(19) United States
(12) Patent Application Publication
(10) Pub. No.: US 2012/0223924 A1
(43) Pub. Date: Sep. 6, 2012

(54) IMAGE PROCESSING APPARATUS

(75) Inventors: Takeo MATSUMOTO, Kobe-shi (JP); Kohji OHNISHI, Kobe-shi (JP); Teruhiko KAMIBAYASHI, Kobe-shi (JP); Shizuka TAMURA, Kobe-shi (JP); Tomoyuki FUJIMOTO, Kobe-shi (JP)

(73) Assignee: FUJITSU TEN LIMITED, Kobe-shi (JP)

(21) Appl. No.: 13/403,356

(22) Filed: Feb. 23, 2012

(30) Foreign Application Priority Data
Mar. 4, 2011 (JP) 2011-047660

(51) Int. Cl. G09G 5/10

(52) U.S. Cl. 345/207; 345/690

(57) ABSTRACT

An image processing apparatus corrects an input image based on a correction amount determined based on an illuminance, and adjusts a specifying value for specifying brightness of a backlight of a display based on the correction amount.

### BACKGROUND OF THE INVENTION

1. Field of the Invention

The invention relates to an image processing apparatus that is operable to ensure visibility of an image by coordinating correction of the image exposed to direct sunlight and brightness adjustment by a user operation.

2. Description of the Background Art

Conventionally, an image display apparatus provided to a car navigation system or the like, to display navigation information leading to a destination, a broadcasted DTV (digital Television) program, images captured by a vehicle-mounted camera, etc., on a display, has been known.

Such an image display apparatus corrects an image to ensure visibility of a display image when the display of the image display apparatus is exposed to direct sunlight.

A well-known technology of such an image correction adjusts the image, for example, by improving the contrast of the image when an illuminance sensor detects direct sunlight incident on the display. Moreover, the image correction is generally made by an image processing circuit provided to the image display apparatus.

In many cases, the image display apparatus has a “brightness adjustment” function that adjusts brightness of a backlight provided to the display, based on an input operation via an adjustment button or the like. Such a brightness adjustment function allows a user to adjust the brightness of the display depending on a taste of the user.

However, in a case of the aforementioned technology, even if the contrast of the image is improved by the image correction, the improved contrast of the image is lowered when the user performs “brightness adjustment” to lower the brightness of the backlight. As a result, there is a possibility that visibility of the display image is difficult to be ensured.

This problem is caused by separate operations of the image correction and the “brightness adjustment.” Therefore, the visibility can be ensured by performing a process that unconditionally increases the brightness of the backlight when the contrast of the display image is improved by the image correction. However, such a process is not preferred because the process gives a feeling of strangeness to the user who has adjusted the brightness of the backlight to be lowered and because electricity consumption increases.

Thus, an issue raised by the points mentioned above is a method of ensuring the visibility when the image on the display exposed to direct sunlight is corrected, without giving the feeling of strangeness to the user who inputs a command for adjusting the brightness of the display.

### SUMMARY OF THE INVENTION

According to one aspect of the invention, an image processing apparatus includes: a corrector that corrects an input image based on a correction amount determined based on an illuminance in an area near a display that displays the input image; and an adjuster that adjusts a specifying value for specifying brightness of a backlight of the display, based on the correction amount.

The image processing apparatus determines the correction amount made to the input image based on the illuminance and corrects the input image based on the correction amount. Moreover, the image processing apparatus adjusts the specifying value for specifying the brightness of the backlight of the display, based on the correction amount. The brightness of the backlight is specified at the specifying value adjusted by the adjuster. Thus the visibility can be ensured by coordinating correction of the image exposed to direct sunlight and brightness adjustment by a user operation.

According to another aspect of the invention, the image processing apparatus further includes a backlight controller that controls the brightness of the backlight based on the specifying value adjusted by the adjuster.

Control of the brightness of the backlight is possible based on the specifying value adjusted by the adjuster. Thus the visibility can be ensured by coordinating correction of the image exposed to direct sunlight and brightness adjustment by a user operation.

Therefore, an object of the invention is to provide an image processing apparatus operable to ensure visibility by coordinating correction of an image exposed to direct sunlight and brightness adjustment by a user operation.

These and other objects, features, aspects and advantages of the invention will become more apparent from the following detailed description of the invention when taken in conjunction with the accompanying drawings.

### BRIEF DESCRIPTION OF THE DRAWINGS

FIG. 1A illustrates an outline of a duty cycle adjustment method using a conventional technology;

FIG. 1B illustrates an outline of a duty cycle adjustment method relating to the invention;

FIG. 1C illustrates an outline of a duty cycle adjustment method relating to the invention;

FIG. 2 is a block diagram illustrating a configuration of an image display system in this embodiment;

FIG. 3 is a block diagram illustrating a configuration of a duty cycle adjuster;

FIG. 4 illustrates an example of setting blend percentage computation information;

FIG. 5 is a flowchart illustrating a procedure performed by an image processing circuit in this embodiment;

FIG. 6A illustrates a conversion curve generated by a duty cycle adjusting circuit of the duty cycle adjuster;

FIG. 6B illustrates an example in which the duty cycle adjusting circuit computes a conversion multiplying coefficient concretely;

FIG. 7 is a diagram for illustrating a lower threshold and an upper threshold of a coefficient;

FIG. 8 is a block diagram for illustrating a configuration of a duty cycle adjuster in a modification; and

FIG. 9 illustrates an example of a conversion curve generated based on a conversion coefficient in a case where an AD value is used as a coefficient.

### DESCRIPTION OF THE EMBODIMENTS

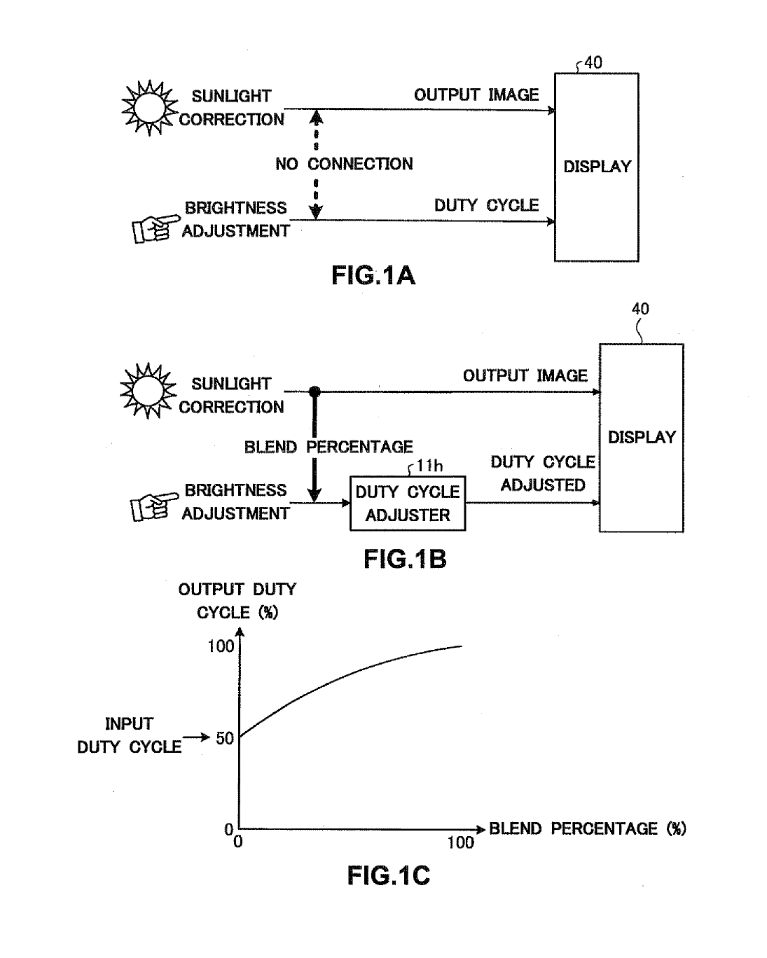

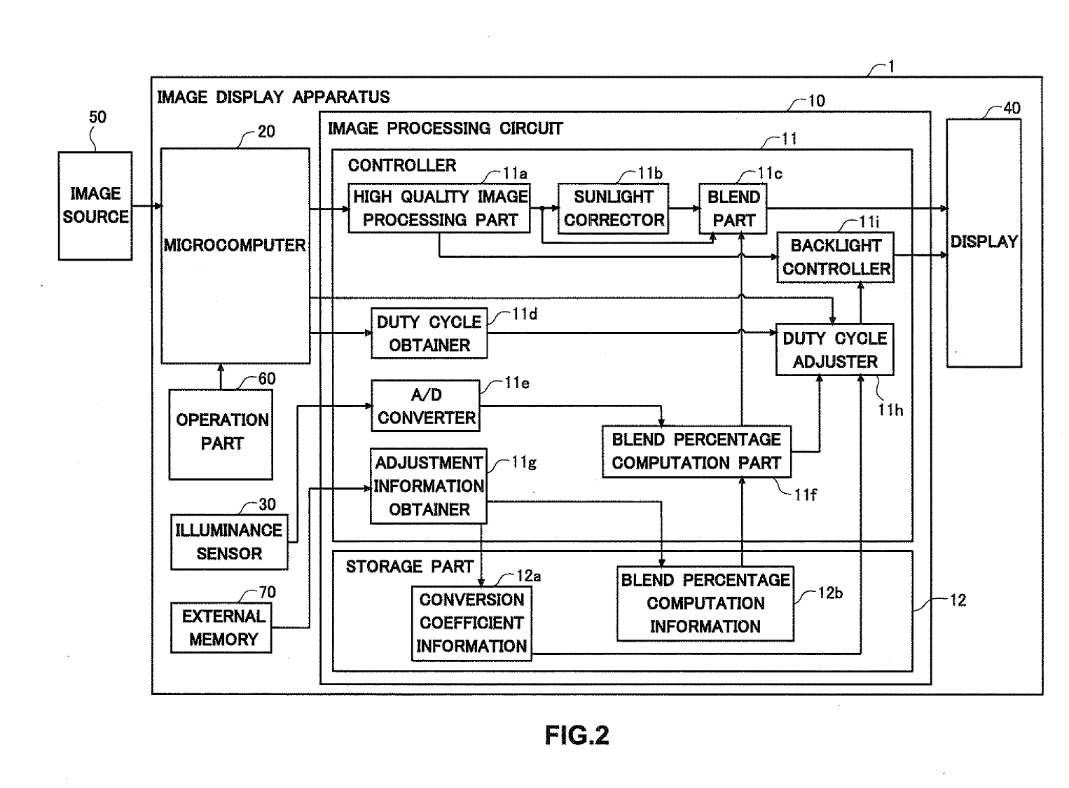

With reference to the attached drawings, an embodiment of the invention is hereinafter described. An outline of a method that is operable to ensure visibility of an image while coordinating correction of the image exposed to direct sunlight and brightness adjustment by a user operation (hereinafter referred to as “duty cycle adjustment method”) is hereinafter described. First described are outlines of duty cycle adjustment methods of a conventional technology and of the invention with reference to FIGS. 1A, 1B and 1C. Then an image processing circuit and an image display apparatus to which the duty cycle adjustment method of the invention is applied are described with reference to FIG. 2 to FIG. 9.

<1. Outline of Duty Cycle Adjustment Method>

First described are outlines of the duty cycle adjustment methods of a conventional technology and of the invention with reference to FIGS. 1A, 1B and 1C. FIG. 1A illustrates an outline of the duty cycle adjustment method of a conventional method. FIG. 1B and FIG. 1C illustrate outlines of the duty cycle adjustment method of the invention.

Hereinafter, an image correction performed when a display is exposed to external light (direct sunlight) is referred to as “sunlight correction.” Moreover, backlight control based on an input operation by the user is referred to as “brightness adjustment.”

As shown in FIG. 1A, the duty cycle adjustment method of the conventional technology controls the “sunlight correction” and the “brightness adjustment” separately. (Refer to “No connection” in FIG. 1A.) Thus when the “sunlight correction” is contradictory to the “brightness adjustment,” visibility of the display image cannot be ensured.

Concretely, even when an output image of which contrast has been improved by the “sunlight correction” is generated and is output to a display 40, the output image generated by the “sunlight correction” is displayed in a state where backlight brightness is insufficient in a case where a duty cycle specified by the “brightness adjustment” lowers the backlight brightness. Thus the output image is difficult to view.

In the duty cycle adjustment method of the invention, an amount of the sunlight correction, in accordance with an illuminance, that is used for the “sunlight correction” is also used for the “brightness adjustment.” As a result, the duty cycle adjustment method of the invention controls the “sunlight correction” and the “brightness adjustment” connectedly.

Concretely, as shown in FIG. 1B, the duty cycle adjustment method of the invention uses “blend percentage” and the like used for the “sunlight correction” also for the “brightness adjustment.” In the duty cycle adjustment method of the invention, a duty cycle adjuster 11h adjusts the duty cycle based on the “blend percentage” and the like.

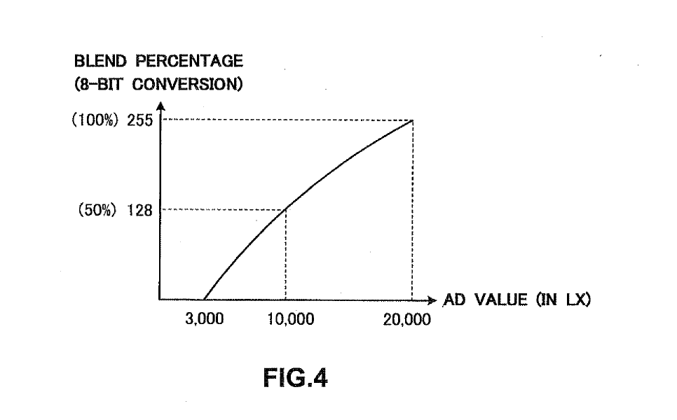

Here, the “blend percentage” refers to a percentage of an image to which the “sunlight correction” has been performed (post-“sunlight correction” image) in an image generated by combining an image to which the “sunlight correction” has not been performed (pre-“sunlight correction” image) with the post-“sunlight correction” image. The “blend percentage” is computed based on the illuminance in a vicinity of the display. As the illuminance in the vicinity of the display increases, the “blend percentage” also increases and the post-“sunlight correction” image accounts for a larger percentage in the image displayed on the display. Therefore, an element based on the illuminance, such as the “blend percentage,” may be referred to as “sunlight correction amount.” The “blend percentage” is described later in detail, with reference to FIG. 4.

As shown in FIG. 1C, the duty cycle adjuster 11h adjusts an input duty cycle (i.e., a duty cycle specified by the user) such that the input duty cycle adjusted (output duty cycle) gradually increases as the “blend percentage” increases.

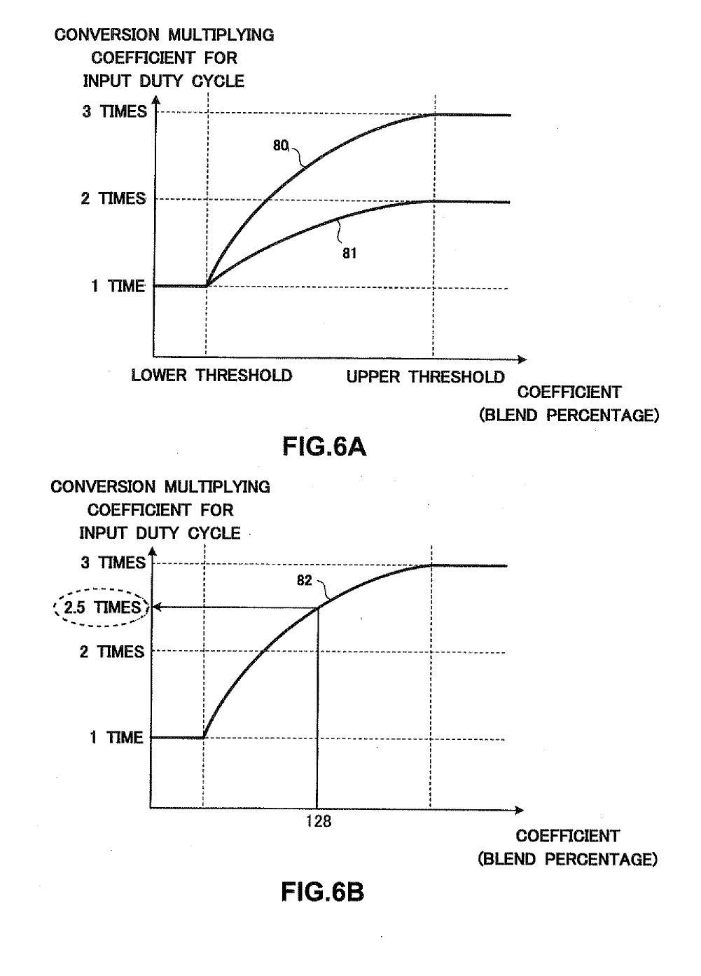

The adjustment is performed based on a “conversion curve” generated by using a predetermined “conversion coefficient.” The “conversion curve” shows a correspondence between the “blend percentage” and a “conversion multiplying coefficient for the input duty cycle.” The adjustment is described later in detail with reference to FIG. 6A and FIG. 6B.

FIG. 1C illustrates an example of a correspondence between the “blend percentage” and the “output duty cycle” in a case of the input duty cycle of 50%. The visibility can be ensured at an earlier time point and the feeling of strangeness given to the user can be prevented by adjusting the output duty cycle to gradually increase to draw a smooth convex curve (a line curved in a positive direction of an axis representing the “output duty cycle”) as shown in FIG. 1C. Moreover, waste of electricity consumed by the backlight can be controlled.

As mentioned above, the duty cycle adjustment method of the invention coordinates the “sunlight correction” with the “brightness adjustment” by using the “sunlight correction amount” used for the “sunlight correction” also for the “brightness adjustment.” Therefore, the duty cycle adjustment method of the invention can ensure the visibility while coordinating the “sunlight correction” with the “brightness adjustment.”

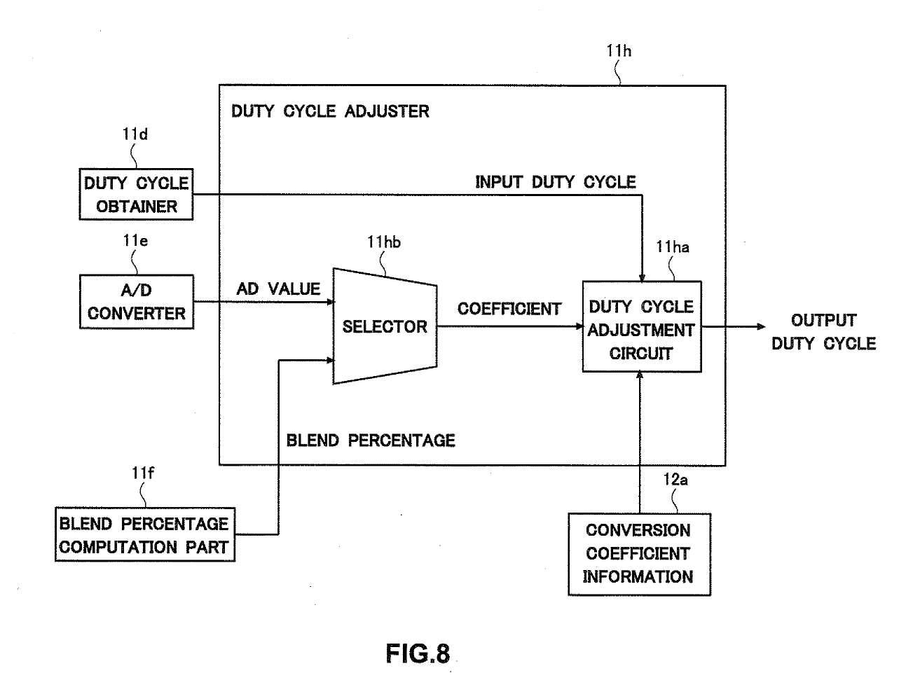

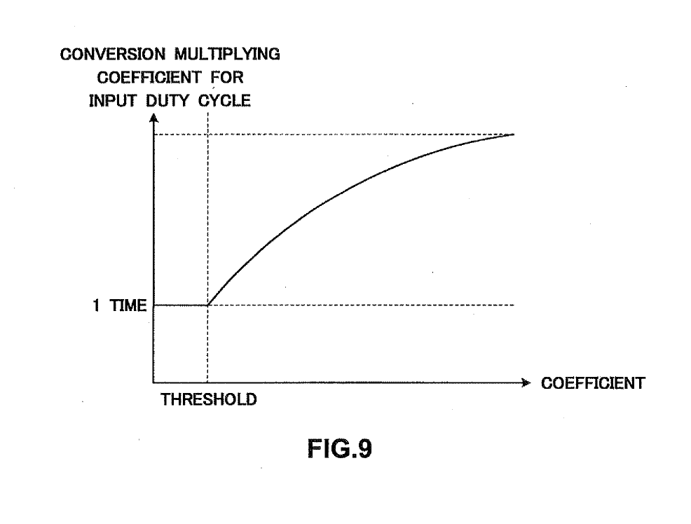

The aforementioned description shows an example in which the “blend percentage” is used as the “sunlight correction amount.” However, an “AD value” that is a digital value obtained by converting an analog value detected by an illuminance sensor may be used instead of the “blend percentage.” The modification using the “AD value” is described later with reference to FIG. 8 and FIG. 9.

### 2. First Embodiment

<2-1. Configuration of Image Display Apparatus>

An image display apparatus using the duty cycle adjustment method of the invention is hereinafter described in detail. FIG. 2 is a block diagram illustrating a configuration of an image display system in this embodiment. The image display system shown in FIG. 2 includes an image display apparatus 1 and an image source connected to the image display apparatus 1. FIG. 2 illustrates components necessary only to explain a characteristic of the image display apparatus 1, and omits general components.

As shown in FIG. 2, the image display apparatus 1 includes a microcomputer 20, an illuminance sensor 30, a display 40, an operation part 60, an external memory 70, and an image processing circuit (image processing apparatus) 10.

The microcomputer 20 is a control unit that performs entire control of the image display apparatus 1. The microcomputer 20 outputs to the image processing circuit 10, an output image output from an image source 50. Moreover, the microcomputer 20 outputs to the image processing circuit 10, information on a type (e.g., DVD and camera) of the output image output from an image source 50. Furthermore, the microcomputer 20 outputs to the image processing circuit 10, information (e.g., a duty cycle according to brightness specified by, a user) input from the operation part 60.

The illuminance sensor 30 is a detection device that is provided in a vicinity of the display 40 and that detects an illuminance in the vicinity of the display 40 as an analog value.

The display 40 displays a composite output image. In this embodiment, the display 40 is a liquid crystal display including a backlight source.

The operation part 60 is an input apparatus that is used for inputting information and that includes a mechanical button, a touch-panel screen or the like. The user can implement various operations made to the display 40 and brightness setting operation by operating the operation part 60.

The external memory 70 is a memory that is composed of a storage device such as a hard disc, a nonvolatile memory, and a register. The external memory 70 stores adjustment information that is original data (not illustrated) of various types of information, such as conversion coefficient information 12a and blend percentage computation information 12b which are both described later.

The image processing circuit 10 includes a controller 11 and a storage part 12, and may be configured as an ASIC (Application Specific Integrated Circuit).

The controller 11 performs entire control of the image processing circuit 10. The controller 11 includes a high quality image processing part 11a, a sunlight corrector 11b, a blend part 11c, a duty cycle obtainer 11d, an A/D converter 11e, a blend percentage computation part 11f, an adjustment information obtainer 11g, a duty cycle adjuster 11h, and a backlight controller 11i.

The high quality image processing part 11a is a processing part that performs a process of improving quality of an input image input from the microcomputer 20. The high quality image processing part 11a outputs the input image of which quality has been improved (hereinafter referred to as “high quality image”) to the sunlight corrector 11b, the blend part 11c, and the backlight controller 11i. Here, the term “improving quality of an image” refers to correcting the outline and colors, mainly, of the input image.

The sunlight corrector 11b is a processing part that corrects visibility, tone, and color saturation of the high quality image input from the high quality image processing part 11a. The sunlight corrector 11b outputs the high quality image corrected, to the blend part 11c.

The blend part 11c is a processing part that generates the composite output image by combining the corrected high quality image input from the sunlight corrector 11b and the high quality image input from the high quality image processing part 11a. The blend part 11c combines the images based on a blend percentage input from the blend percentage computation part 11f. Moreover, the blend part 11c outputs the composite output image to the display 40.

The duty cycle obtainer 11d is a processing part that obtains an input duty cycle from the microcomputer 20, and that outputs the input duty cycle obtained to the duty cycle adjuster 11h.

The A/D converter 11e is a processing part that converts an analog value detected by the illuminance sensor 30 to a digital value (AD value). The A/D converter 11e outputs an AD value to the blend percentage computation part 11f.

The blend percentage computation part 11f is a processing part that computes the blend percentage of the high quality image corrected in the composite output image. The blend percentage computation part 11f computes the blend percentage based on the AD value input from the A/D converter 11e and on the blend percentage computation information 12b stored in the storage part 12. Moreover, the blend percentage computation part 11f outputs the blend percentage computed, to the blend part 11e and to the duty cycle adjuster 11h.

The adjustment information obtainer 11g is a processing part that obtains the adjustment data (not illustrated) that is the original data of various types of information such as the conversion coefficient information 12a and the blend percentage computation information 12b, from the external memory 70 in an initial running phase of the image processing circuit 10 when, for example, the image display apparatus 1 is powered on. Moreover, the adjustment information obtainer 11g causes the storage part 12 to store the adjustment information obtained as the conversion coefficient information 12a and as the blend percentage computation information 12b.

The duty cycle adjuster 11h is a processing part that computes an input duty cycle adjusted (output duty cycle) by adjusting the input duty cycle input from the duty cycle obtainer 11d. The duty cycle adjuster 11h computes the output duty cycle based on the blend percentage input from the blend percentage computation part 11f and on the conversion coefficient information 12a stored in the storage part 12. Moreover, the duty cycle adjuster 11h outputs the output duty cycle computed to the backlight controller 11i.

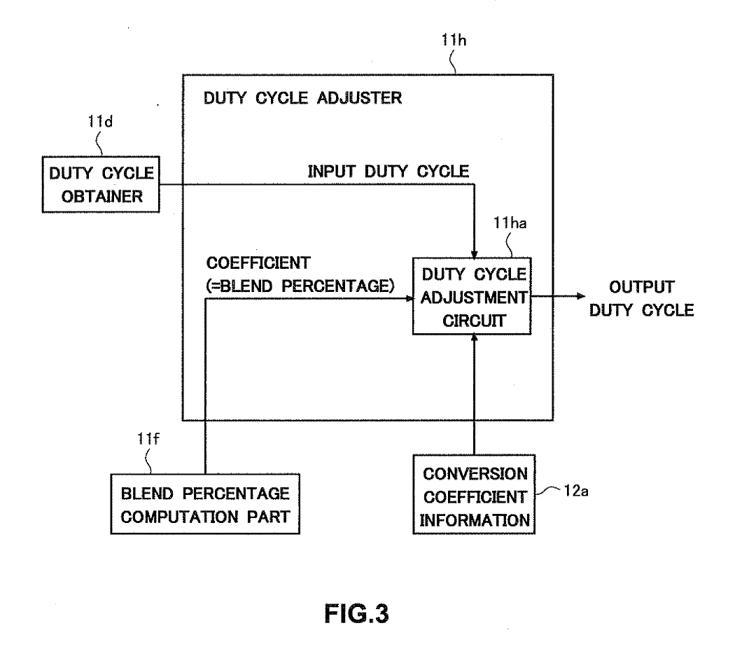

Here, the duty cycle adjuster 11h is described in more detail with reference to FIG. 3. FIG. 3 is a block diagram that illustrates a configuration of the duty cycle adjuster 11h. As shown in FIG. 3, the duty cycle adjuster 11h includes a duty cycle adjustment circuit 11ha.

The duty cycle adjustment circuit 11ha computes a conversion multiplying coefficient for the input duty cycle and further computes the output duty cycle based on the conversion multiplying coefficient computed and on the input duty cycle input from the duty cycle obtainer 11d. Then the duty cycle adjustment circuit 11ha outputs the output duty cycle computed.

The conversion multiplying coefficient for the input duty cycle is computed based on a conversion curve generated on the basis of a predetermined conversion coefficient included in the conversion coefficient information 12a, later described, a lower threshold and an upper threshold. Concretely, the conversion curve is generated as a graph on a coordinate plane having an x-axis representing the blend percentage (coefficient) input from the blend percentage computation part 11f and a y-axis representing the conversion multiplying coefficient for the input duty cycle. A value on the conversion curve corresponding to the blend percentage input is the conversion multiplying coefficient for the input duty cycle.

Moreover, the duty cycle adjustment circuit 11ha, not illustrated, receives information about a type of the image source 50 (refer to FIG. 2) from the microcomputer 20 (refer to FIG. 2), and refers to the conversion coefficient information 12a to determine a conversion coefficient corresponding to the type of the image source 50.

With reference back to FIG. 2, the backlight controller 11i is a processing part that generates a backlight brightness control signal for controlling the brightness of the backlight source included in the display 40, based on image brightness of the high quality image input from the high quality image processing part 11a and on the output duty cycle input from the duty cycle adjuster 11h. Moreover, the backlight controller 11i outputs the brightness control signal generated, to the display 40.

The storage part 12 is composed of a storage device such as a nonvolatile memory and a register, and stores the conversion coefficient information 12a and the blend percentage computation information 12b.

The conversion coefficient information 12a is information showing a correspondence between the types of the image source 50 and the conversion coefficients.

Here, with reference to FIG. 4, the blend percentage computation information 12b is explained. FIG. 4 illustrates an example of setting the blend percentage computation information 12b. As shown in FIG. 4, the blend percentage computation information 12b is represented by a “blend percentage curve” showing a correspondence between the blend percentages and the AD values.

FIG. 4 shows the blend percentage curve on a coordinate plane having an x-axis representing the AD value in lux and a y-axis representing the blend percentage converted in 8 bits. When the blend percentage curve is used, the blend percentage is computed as “128 (50%)” in a case where the AD value is “10,000” and the blend percentage is computed as “255 (100%)” in a case where the AD value is “20,000.”

When the AD value is “3,000” or less, the blend percentage is “0 (0%).” In other words, in an example shown in FIG. 4, the AD value of “3,000” is a threshold for determining whether or not the sunlight correction is performed. Moreover, by using a blend percentage curve that is smoothly convex as shown in FIG. 4, the sunlight correction can be performed at an earlier time point.

<2-2. Behavior of Image Processing Circuit>

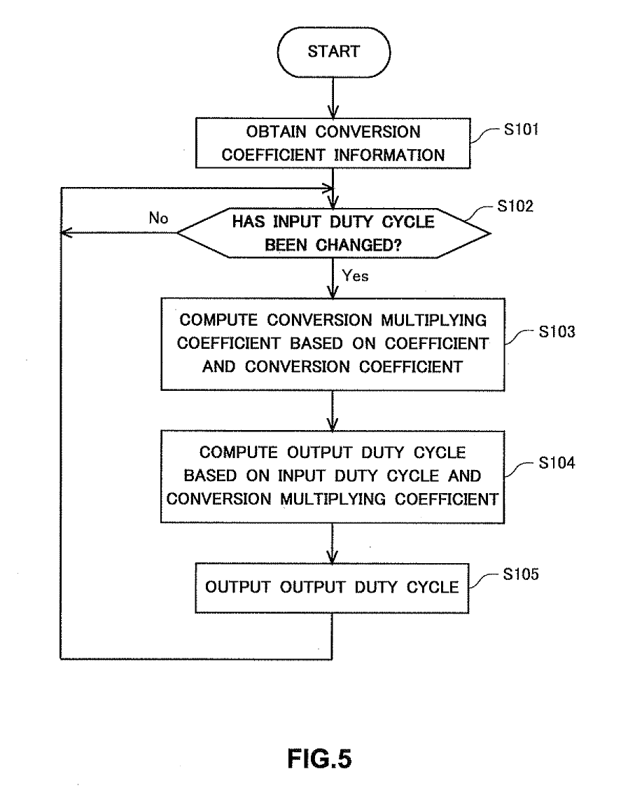

Next described is behavior of the image processing circuit 10 in this embodiment. FIG. 5 is a flowchart illustrating a procedure performed by the image processing circuit 10 in the embodiment.

As shown in FIG. 5, in the initial running phase of the image processing circuit 10 when, for example, the image display apparatus 1 is powered on, the image processing circuit 10 obtains the adjustment information including the original data of the conversion coefficient information 12a, from the external memory 70, and stores the adjustment information obtained into the storage part 12 (a step S101). The adjustment information may include the blend percentage computation information 12b.

Next, the image processing circuit 10 determines whether or not the input duty cycle has been changed (a step S102). When the input duty cycle has been changed (Yes in the step S102), the image processing circuit 10 computes the conversion multiplying coefficient on the basis of the coefficient based on the illuminance in the vicinity of the display 40 and of the conversion coefficient corresponding to the type of the image source 50 in the conversion coefficient information 12a (a step S103). On the other hand, when the input duty cycle has not been changed (No in the step S102), the image processing circuit 10 repeats the process from the step S102.

Then the image processing circuit 10 computes the output duty cycle based on the input duty cycle and on the conversion multiplying coefficient computed in the step S103 (a step S104). Then the image processing circuit 10 outputs the backlight brightness control signal including the output duty cycle computed, to the display 40 (a step S105) and then repeats the process from the step S102.

Here, the process of computing the output duty cycle (the steps S103 and S104) is described in detail. As mentioned above, the conversion multiplying coefficient for the input duty cycle is computed by the duty cycle adjuster 11h, and then the output duty cycle is computed based on the conversion multiplying coefficient computed and on the input duty cycle.

FIG. 6A illustrates a conversion curve generated by the duty cycle adjustment circuit 11ha of the duty cycle adjuster 11h. FIG. 6B illustrates an example in which the duty cycle adjustment circuit 11ha computes the conversion multiplying coefficient concretely.

As shown in FIG. 6A, the duty cycle adjustment circuit 11ha generates the conversion curve that shows a correspondence between the blend percentage input as the coefficient and the conversion multiplying coefficient for the input duty cycle. The conversion curve is generated on the basis of the predetermined conversion coefficient included in the conversion coefficient information 12a, the lower threshold and the upper threshold.

The predetermined conversion coefficient is a combination of constants determined in advance corresponding to the type of the image source 50 (refer to FIG. 2). In this embodiment, the predetermined conversion coefficient is a combination of three constants a, b, and c.

The duty cycle adjustment circuit 11ha first receives the conversion coefficient corresponding to the type of the image source 50 from the conversion coefficient information 12a, and then generates the conversion curve based on the conversion coefficient. Here, when the conversion multiplying coefficient for the input duty cycle is p and when the coefficient is x, the conversion multiplying coefficient p for the input duty cycle is computed by a formula “p=ax²+bx+c.”

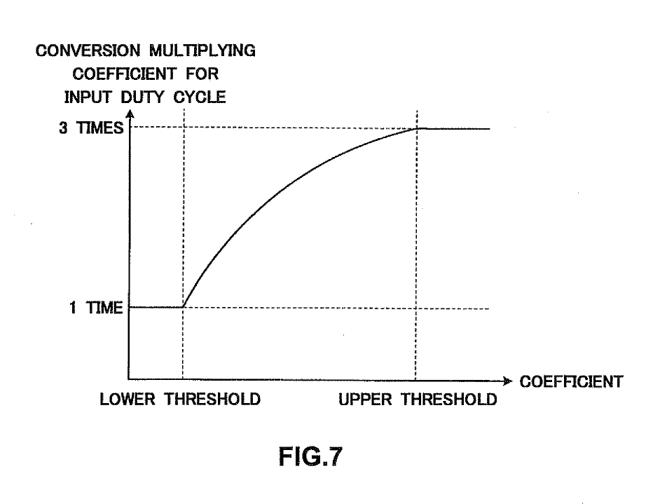

In other words, the duty cycle adjustment circuit 11ha generates a curve representing the quadratic equation as the conversion curve. When the coefficient x is smaller than the lower threshold, or when the coefficient x is greater than the upper threshold, the conversion multiplying coefficient p is fixed. This case is described later with reference to FIG. 7.

Therefore, when the type of the image source 50 is changed, the duty cycle adjustment circuit 11ha obtains a different conversion coefficient that is a combination of different a, b, and c corresponding to the different type changed of the image source 50, and then generates a fresh conversion curve.

In other words, conversion curves 80 and 81 shown in FIG. 6A are two different conversion curves of which conversion coefficients, i.e., the types of the image source 50, are different.

As shown in FIG. 6B, the duty cycle adjustment circuit 11ha computes the conversion multiplying coefficient for the input duty cycle based on the conversion curve generated, and further computes the output duty cycle based on the conversion multiplying coefficient computed and on the input duty cycle.

FIG. 6B illustrates an example in which the input duty cycle of “30%” is input and also the coefficient of “128” (8-bit converted value) is input. Moreover, in the example, the duty cycle adjustment circuit 11ha has already generated a conversion curve 82 shown in FIG. 6B.

The duty cycle adjustment circuit 11ha computes the conversion multiplying coefficient corresponding to the coefficient input, based on the conversion curve 82. For example, the duty cycle adjustment circuit 11ha computes the conversion multiplying coefficient of “2.5 times” for the input duty cycle corresponding to the coefficient of “128.”

The duty cycle adjustment circuit 11ha computes the output duty cycle based on the conversion multiplying coefficient computed and on the input duty cycle. For example, when the input duty cycle is “30%” and the conversion multiplying coefficient computed is “2.5 times,” the output duty cycle of “75%” is obtained by multiplying the input duty cycle “30%” by the conversion multiplying coefficient computed “2.5 times” (output duty cycle=30%×2.5=75%).

When the output duty cycle exceeds “100%,” the output duty cycle may be fixed at “100%.” Moreover, when the conversion coefficient is not changed (i.e., the type of the image source 50 is not changed), a same conversion curve is used even if a different value of the input duty cycle is input.

Here, the lower threshold and the upper threshold of the coefficient shown in FIG. 6A are explained with reference to FIG. 7. FIG. 7 explains the lower threshold and the upper threshold of the coefficient, and illustrates an example of the conversion curve generated on the basis of the conversion coefficient, the lower threshold and the upper threshold.

The duty cycle adjustment circuit 11ha is operable to generate the conversion curve including the “lower threshold” or the “upper threshold” like the conversion curve shown in FIG. 7. The “lower threshold” or the “upper threshold” may be included in the conversion coefficient information 12a along with the conversion coefficient, or may be stored in the duty cycle adjustment circuit 11ha in advance.

As shown in FIG. 7, when the coefficient is smaller than the “lower threshold,” or when the coefficient is greater than the “upper threshold,” the duty cycle adjustment circuit 11ha generates the conversion curve from which a fixed conversion multiplying coefficient is obtained.

FIG. 7 illustrates an example in which the conversion multiplying coefficient is “1” when the coefficient is smaller than the “lower threshold,” and in which the conversion multiplying coefficient is “3” when the coefficient is greater than the “upper threshold.”

In other words, when a coefficient smaller than the “lower threshold” is input, the output duty cycle is the same as the input duty cycle (i.e., the input is multiplied by “1”). Thus, it is possible to perform control that causes the output duty cycle to be the input duty cycle of “brightness adjustment” input by the user when the illuminance in the vicinity of the display 40 is less than a predetermined minimum illuminance because the coefficient is the blend percentage based on the illuminance in the vicinity of the display 40.

When the coefficient greater than the “upper threshold” is input, the output duty cycle is fixed at a predetermined multiplying coefficient (“3” in this case) of the input duty cycle. In other words, it is possible to perform control that disables the input duty cycle of “brightness adjustment” input by the user when the illuminance in the vicinity of the display 40 exceeds a predetermined maximum illuminance.

As shown in FIG. 7, a preferable conversion curve forms an arc in a region from the “lower threshold” to the “upper threshold” because control according to such a conversion curve is able to prevent the user from feeling strange.

As described above, in the image processing circuit 10 in this embodiment, the storage part 12 stores the conversion coefficient information 12a, and the blend percentage computation part 11f computes the blend percentage equivalent to an amount of the sunlight correction based on the illuminance. Then the duty cycle adjuster 11h generates, on the basis of the conversion coefficient information 12a and of the blend percentage, the output duty cycle by adjusting the input duty cycle specified based on an input operation by the user. As a result, visibility of an image can be ensured while coordinating correction of the image exposed to direct sunlight and brightness adjustment by the user operation.

### 3. Modifications

In the embodiment described above, the blend percentage is used as the coefficient. A modification in which one of a blend percentage and an AD value is used as the coefficient, is hereinafter described with reference to FIG. 8. FIG. 8 is a block diagram illustrating a configuration of a duty cycle adjuster 11h in the modification. In FIG. 8, same numerical references refer to same components shown in FIG. 3, and the same components shown in FIG. 3 are not explained or are briefly explained, hereinafter.

As shown in FIG. 8, the duty cycle adjuster 11h in the modification further includes a selector 11hb, which makes the duty cycle adjuster 11h in the modification different from the duty cycle adjuster 11h in the embodiment shown in FIG. 3.

The selector 11hb receives an AD value input from an A/D converter 11e and a blend percentage input from a blend percentage computation part 11f. The selector 11hb selects one of the AD value input and the blend percentage input, to use as a coefficient. One of the coefficients may be selected by a selection command from a microcomputer 20, or may be determined by hard-wired logic and the like.

The blend percentage computed by the blend percentage computation part 11f may be, for example, an averaged value of the AD values output from the A/D converter 11e. Therefore, in such a case, the AD value that is original data of the blend percentage is usable as the coefficient. As a result, response speed to an actual change of the illuminance can be improved.

Here, with reference to FIG. 9, a conversion coefficient when the AD value is used as the coefficient is described. FIG. 9 illustrates an example of a conversion curve generated based on the conversion coefficient when the AD value is used as the coefficient.

As shown in FIG. 9, when the AD value is used as the coefficient, it is preferable that the conversion curve forms a line representing that a conversion multiplying coefficient for an input duty cycle is one (1) (i.e., the input duty cycle is the same as an output duty cycle) in a case where the coefficient is less than a predetermined threshold specified for the coefficient.

That is because the AD value has a disadvantage of containing more noise as compared to the blend percentage while having an advantage of improving the response speed to the actual change of the illuminance.

Thus, when the AD value is used as the coefficient, it is preferable to use a conversion coefficient different from the conversion coefficient used in a case where the blend percentage is used as the coefficient, in order to prevent the input duty cycle specified by a user from being changed due to a slight change of the illuminance.

Therefore, a different conversion coefficient can be set to conversion coefficient information 12a according to a type (e.g., the blend percentage and the AD value) of input data used as the coefficient.

As a result, the visibility of a display image can be ensured without decreasing accuracy of the output duty cycle regardless of the type of the input data used as the coefficient.

As described above, the image processing apparatus and the image display apparatus of the invention are utilized when visibility of an image is required to be ensured while coordinating correction of the image exposed to direct sunlight and brightness adjustment by the user operation. Especially, the invention is suitable to be applied to a vehicle-mounted image processing apparatus and a vehicle-mounted image display apparatus often exposed to direct sunlight.

While the invention has been shown and described in detail, the foregoing description is in all aspects illustrative and not restrictive. It is therefore understood that numerous other modifications and variations can be devised without departing from the scope of the invention.

What is claimed is:

1. An image processing apparatus comprising:
a corrector that corrects an input image based on a correction amount determined based on an illuminance in an area near a display that displays the input image; and
an adjuster that adjusts a specifying value for specifying brightness of a backlight of the display, based on the correction amount.

2. The image processing apparatus according to claim 1, further comprising
a backlight controller that controls the brightness of the backlight based on the specifying value adjusted by the adjuster.

3. The image processing apparatus according to claim 1, wherein
the adjuster adjusts the specifying value such that the specifying value approaches a maximum brightness of the backlight as the correction amount increases.

4. The image processing apparatus according to claim 1, wherein
the adjuster does not adjust the specifying value when the correction amount is less than a predetermined lower threshold.

5. The image processing apparatus according to claim 1, wherein
the adjuster adjusts the specifying value to a maximum brightness of the backlight when the correction amount exceeds a predetermined upper threshold.

6. The image processing apparatus according to claim 1, further comprising
a memory that stores a conversion coefficient relating to conversion of the specifying value, corresponding to a type of the input image, and
wherein when a fresh specifying value is input, the adjuster adjusts the fresh specifying value based on the correction amount and on the conversion coefficient corresponding to the type of the input image.

7. The image processing apparatus according to claim 1, wherein
the correction amount is one of the illuminance and an averaged value of the illuminance.

8. An image display apparatus comprising:
a display on which an input image is displayed;
an illuminance detector that detects an illuminance in an area near the display; and
an image processing apparatus including (i) a corrector that corrects the input image based on a correction amount determined based on the detected illuminance and (ii) an adjuster that adjusts a specifying value for specifying brightness of a backlight of the display based on the correction amount.

9. The image display apparatus according to claim 8, wherein the image processing apparatus further includes
a backlight controller that controls the brightness of the backlight based on the specifying value adjusted by the adjuster.

10. The image display apparatus according to claim 8, wherein
the adjuster adjusts the specifying value such that the specifying value approaches a maximum brightness of the backlight as the correction amount increases.

11. The image display apparatus according to claim 8, wherein
the adjuster does not adjust the specifying value when the correction amount is less than a predetermined lower threshold.

12. The image display apparatus according to claim 8, wherein
the adjuster adjusts the specifying value to a maximum brightness of the backlight when the correction amount exceeds a predetermined upper threshold.

13. The image display apparatus according to claim 8, wherein the image processing apparatus further includes
a memory that stores a conversion coefficient relating to conversion of the specifying value, corresponding to a type of the input image, and
wherein when a fresh specifying value is input, the adjuster adjusts the fresh specifying value based on the correction amount and on the conversion coefficient corresponding to the type of the input image.

14. The image display apparatus according to claim 8, wherein
the correction amount is one of the illuminance and an averaged value of the illuminance.

15. An image processing circuit that corrects an input image in accordance with an illuminance in an area near a display on which the input image is to be displayed, the image processing circuit comprising:
a corrector that determines a correction amount for the input image based on the illuminance and that corrects the input image based on the correction amount;
an adjuster that receives a specifying value based on a user operation for brightness of a backlight of the display and that adjusts the specifying value based on the correction amount; and
a backlight controller that controls the brightness of the backlight based on the specifying value adjusted by the adjuster.

16. The image processing circuit according to claim 15, wherein
the adjuster adjusts the specifying value such that the specifying value approaches a maximum brightness of the backlight as the correction amount increases.

17. The image processing circuit according to claim 15, wherein
the adjuster does not adjust the specifying value when the correction amount is less than a predetermined lower threshold.

18. The image processing circuit according to claim 15, wherein
the adjuster adjusts the specifying value to a maximum brightness of the backlight when the correction amount exceeds a predetermined upper threshold.

19. The image processing circuit according to claim 15, further comprising
a memory that stores a conversion coefficient relating to conversion of the specifying value, corresponding to a type of the input image, and
wherein when a fresh specifying value is input, the adjuster adjusts the fresh specifying value based on the correction amount and on the conversion coefficient corresponding to the type of the input image.

20. The image processing circuit according to claim 15, wherein
the correction amount is one of the illuminance and an averaged value of the illuminance.
